(19) United States
(12) Patent Application Publication
(10) Pub. No.: US 2008/0178957 A1
(43) Pub. Date: Jul. 31, 2008

(54) Tube assembly

(75) Inventors: Kurt Judson Thomas, Indianapolis, IN (US); Thomas C. Pinette, Indianapolis, IN (US)

Correspondence Address: BAKER & DANIELS LLP, 300 NORTH MERIDIAN STREET, SUITE 2700, INDIANAPOLIS, IN, 46204, US

(73) Assignee: MASCO CORPORATION OF INDIANA, Indianapolis, IN (US)

(21) Appl. No.: 11/700,640

(22) Filed: Jan. 31, 2007

(51) Int. Cl. F16L 11/00

(52) U.S. Cl. 138/121; 137/801; 138/123; 4/678; 138/109

(57) ABSTRACT

A corrugated tube assembly for use in connection with a plumbing fixture. The corrugated tube assembly includes a first tubular member and a second tubular member coaxially receiving the first tubular member. The first tubular member illustratively includes a cross-linked polymer, and the second tubular member illustratively includes a plurality of interconnected strands.

### BACKGROUND AND SUMMARY OF THE INVENTION

The present invention relates generally to fluid carrying systems and, more particularly, to tube assemblies for use in connection with faucets.

It is widely known to utilize copper tubing in many plumbing installations. For example, copper risers are often used for fluidly coupling hot and cold water supplies to faucets.

However, the cost of such copper tubing and the complexities of installation are frequently significant. Further, there is a growing concern about the quality of potable water. The U.S. Environmental Protection Agency, NSF International (National Sanitary Foundation) and other health-related organizations are seeking to reduce the metal content (i.e., copper and lead) in water. The use of plastic materials for waterways is known to reduce cost, eliminate metal contact, and to also provide protection against acidic and other aggressive water conditions.

It is also known to use for waterways not only thermoplastic materials, e.g., polypropylene, polybutylene, etc., but also combined thermoplastic/thermoset materials, e.g., cross-linked polyethylene (PEX), wherein at least a portion of the polymer is cross-linked. For example, it is known to use in plumbing tubes a cross-linked polyethylene having approximately 65 percent thermoset material and 35 percent thermoplastic material.

As is known, polyethylene is flexible and may be cross-linked to form PEX. Cross-linking polyethylene couples the individual molecule chains together and prevents splitting. The curing or cross-linking process may use any one of several different technologies to form, for example, PEX-A, PEX-B or PEX-C. PEX-A is formed by using peroxide to cross-link polyethylene. More particularly, PEX-A is formed of a polyethylene having incorporated therein peroxide. Upon heating the peroxide polyethylene above the decomposition temperature of the peroxide, “free” radicals are produced to initiate the cross-linking process. PEX-B is formed by using silane to cross-link polyethylene. PEX-B is formed by using silane-grafted polyethylene which is then “moisture-cured” by exposure to heat and water, also known as sauna curing. PEX-C is formed of polyethylene which is cross-linked by bombarding it with electromagnetic (gamma) or high energy electron (beta) radiation.

PEX is known to be durable under temperature extremes, to withstand chemical attacks, and to resist creep deformation. As such, PEX is an excellent material for a variety of uses, including hot water applications.

According to an illustrative embodiment of the present disclosure, a tube assembly for use with a faucet comprises a first tubular member formed of a polymer and including a plurality of corrugations. A second tubular member coaxially receives the first tubular member and includes a plurality of braided strands.

According to a further illustrative embodiment of the present disclosure, a tube assembly for use with a faucet includes a first tubular member formed of a cross-linked polyethylene. The first tubular member includes a sidewall having a plurality of corrugations. A second tubular member receives the first tubular member.

According to another illustrative embodiment of the present disclosure, a tube assembly for use with a faucet includes an inner tubular member extending between opposing first and second ends, and formed of cross-linked polyethylene. The inner tubular member includes a sidewall having a plurality of corrugations. An outer tubular member extends between opposing first and second ends, and receives the inner tubular member. The outer tubular member includes a plurality of interwoven cross-linked polyethylene strands. An end fitting is overmolded around the first end of the inner tubular member and the first end of the outer tubular member.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 is a perspective view of an illustrative embodiment faucet assembly utilizing the tube assembly of the present disclosure;

FIG. 2 is a perspective view with a partial cut-away of an illustrative embodiment tube assembly;

FIG. 3 is a side elevational view, in partial cross-section, of the tube assembly of FIG. 1;

FIG. 4 is a detailed view of a first end of the tube assembly of FIG. 3;

FIG. 5 is a detailed view of a second end of the tube assembly of FIG. 3; and

FIG. 6 is a detailed view similar to FIG. 4 of another illustrative embodiment tube assembly.

Corresponding reference characters indicate corresponding parts throughout the several views. Although the drawings represent embodiments of the present invention, the drawings are not necessarily to scale and certain features may be exaggerated in order to better illustrate and explain the present invention.

### DETAILED DESCRIPTION OF THE DRAWINGS

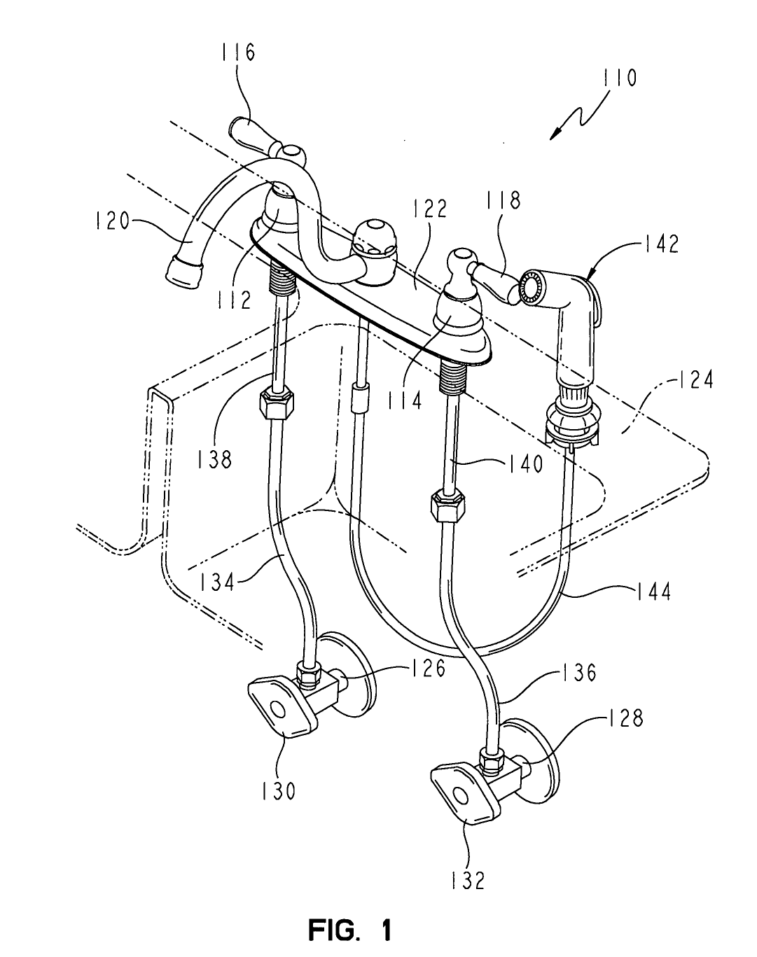

Referring initially to FIG. 1, a faucet assembly 110 is shown for use with the illustrative embodiment tube assemblies 10 of the present disclosure. The faucet assembly 110 illustratively includes hot and cold water valves 112 and 114 operably coupled to rotatable handles 116 and 118. A delivery spout 120 is supported above an escutcheon 122 which, in turn, is supported on a sink deck 124. The hot and cold water valves 112 and 114 are fluidly coupled to hot and cold water supply lines 126 and 128 through conventional stops 130 and 132, respectively. Hot and cold risers 134 and 136 fluidly couple the stops 130 and 132 to hot and cold water inlet lines 138 and 140, respectively. Inlet lines 138 and 140 are, in turn, coupled to the hot and cold water valves 112 and 114, respectively. In a further illustrative embodiment, the faucet assembly 110 includes a conventional side spray 142 fluidly coupled to the hot and cold water valve bodies by an outlet line 144.

As noted above, the hot and cold water risers 134 and 136, and the hot and cold water inlet lines 138 and 140 are conventionally formed of copper. In the illustrative embodiment, the risers 134 and 136 and inlet lines 138 and 140, as well as the outline line 144, may be formed of the illustrative embodiment tube assembly 10 of the present disclosure. The tube assembly 10 could also be used in connection with a pull-out wand removably supported by a faucet spout (not shown).

While the tube assembly 10 detailed herein is shown for use in connection with a faucet assembly 110, it should be appreciated that the tube assembly 10 may find equal applicability with other plumbing fixtures.

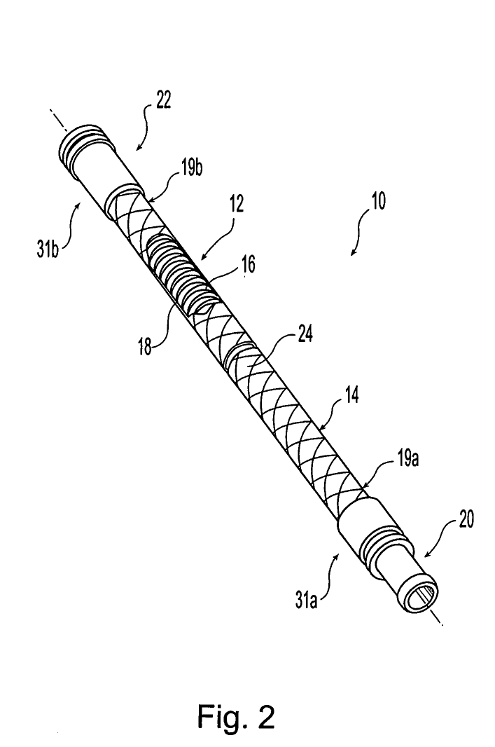

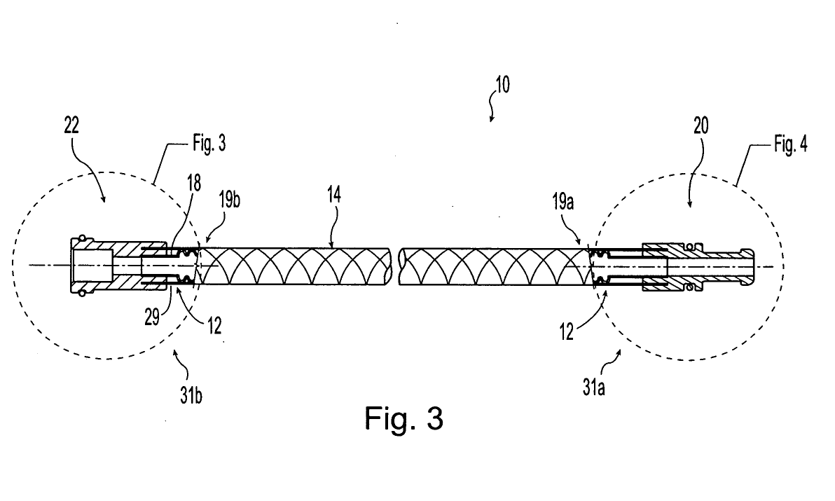

FIGS. 2 and 3 show an illustrative embodiment tube assembly 10 including an inner tubular member 12 and an outer tubular member 14 coaxially disposed about inner tubular member 12. Inner tubular member 12 comprises a polymer, illustratively a cross-linked polyethylene (PEX) or a polyamide. Inner tubular member 12 includes a plurality of corrugations 16 formed within sidewall 18 and extending between opposing ends 19a and 19b.

Corrugations 16 facilitate flexibility of tube assembly 10. More particularly, the corrugations 16 provide the inner tubular member 12 with greater flexibility for the same thickness of sidewall 18.

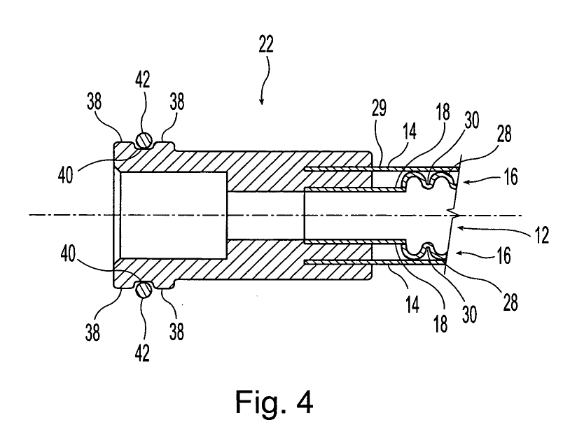

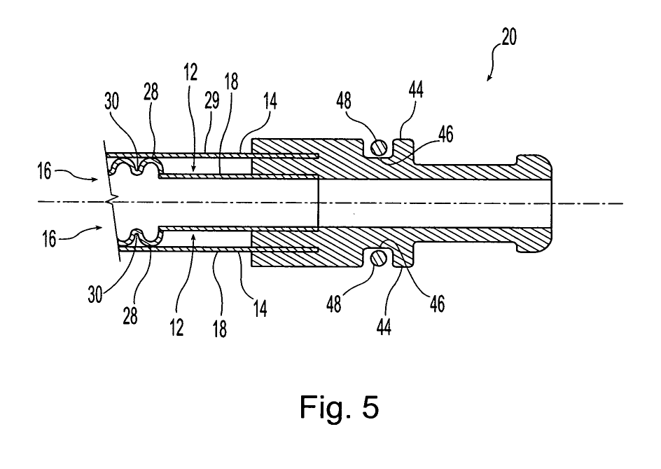

As also shown in FIGS. 4 and 5, corrugations 16 illustratively include radially outwardly projecting annular ridges 28 and radially inwardly projecting annular valleys 30. Corrugations 16 may also be of convoluted forms wherein ridges 28 and valleys 30 are not annular but defined by coils or spirals. Corrugations 16 may be formed within sidewall 18 prior to cross-linking by passing the uncorrugated tubular member 12 through a corrugator (not shown), which intermittently engages the sidewall 18. The corrugator may be of a type known in the art to use a combination of a mold and a vacuum. The vacuum is provided in the mold to draw the sidewall 18 into mold dies having the shape of the desired corrugations 16.

The corrugator may also form the corrugations 16 within sidewall 18 prior to cross-linking by using a combination of a mold and pressure (i.e., blow molding). A pressurized fluid, for example, air, is provided inside the uncorrugated tubular member 12 to prevent or limit collapse of the member 12 as mold dies are compressed therearound. Again, the mold dies have the shape of the desired corrugations 16.

Referring again to FIGS. 2 and 3, outer tubular member 14 illustratively comprises a polymer, such as a cross-linked polyethylene (PEX) or polyamide. The outer tubular member 14 may be formed of other suitable materials, such as fiberglass, nylon webbing, stainless steel, etc. In the illustrated embodiment, outer tubular member 14 comprises a braided sleeve including a sidewall 29 having a plurality of interwoven or braided strands 24 of PEX extending between opposing ends 31a and 31b. By braiding outer tubular member 14, strength and abrasion resistance is increased. Outer tubular member 14 positioned over inner tubular member 12 provides for increased axial and radial strength. As discussed in more detail below, outer tubular member 14 and inner tubular member 12 are illustratively overmolded together prior to cross-linking, thereby fixing the relative positions of their respective ends 19a, 19b, and 31a, 31b. Braided strands 24 also improve the aesthetics of the finished tube assembly 10.

In one illustrative embodiment, the inner and outer tubular members 12 and 14 are formed of a polyethylene which is subsequently cross-linked to form cross-linked polyethylene (PEX). However, it should be appreciated that other polymers may be substituted therefor. For example, the tubular members 12 and 14 may be formed of any polyethylene (PE)(such as raised temperature resistant polyethylene (PE-RT)), of polypropylene (PP)(such as polypropylene random (PPR)), or of polybutylene (PB). It is further envisioned that the tubular members 12 and 14 could be formed of cross-linked polyvinyl chloride (PVCX) using silane free radical initiators, of cross-linked polyurethane, or of cross-linked propylene (XLPP) using peroxide or silane free radical initiators.

As shown in FIG. 3, tube assembly 10 illustratively includes end couplings or fittings 20 and 22 coupled to ends 19a, 31a and 19b, 31b, respectively. Inner tubular member 12 and outer tubular member 14 may be co-axially disposed as also shown in FIG. 3. In the illustrative embodiment, and as further detailed herein, end fittings 20 and 22 may be overmolded on ends 19a and 19b of tube assembly 10.

End fittings 20 and 22 may comprise any known fluid fitting utilized to facilitate fluid connections. Illustratively, end fittings 20 and 22 are formed of a material compatible with the inner and outer members 12 and 14. More particularly, the end fittings 20 and 22 may be formed of a cross-linkable material, such as polyethylene or polyamide. As illustrated in FIG. 4, end fitting 22 includes annular rings 38 defining annular groove 40 configured to receive a seal, such as o-ring 42. As illustrated in FIG. 5, end fitting 20 includes annular rings 44 defining annular groove 46 again configured to receive a seal, such as o-ring 48. Inner tubular member 12 and outer tubular member 14 may be crimped or otherwise secured to end fittings 20 and 22 by other suitable fastening methods.

In the illustrative embodiment, end fittings 20 and 22 are secured to ends 19a, 31a and 19b, 31b of inner and outer tubular members 12 and 14 through overmolding. The basic principle of overmolding plumbing connections onto tubular members is well known. More particularly, a mandrel may be inserted within inner tubular member 112 to prevent its collapse during the molding operation. A mold receives the coaxially disposed respective ends 19a, 31a and 19b, 31b of the tubular member 112 and 114 and receives a flowable polymer which forms the appropriate fitting 20, 22. The mold is then opened to release the overmolded fitting 20, 22 and tubular members 12, 14.

During the overmolding process, the inner and outer tubular members 12 and 14 melt and bond with the overmolded material of the respective fitting 20, 22. Such a material to material bond facilitates a heat-resistant connection, and makes a substantially monolithic tube assembly 10.

The formed tube assembly 10 may then be cross-linked. Cross-linking can of course, be accomplished in many different ways. In the illustrative embodiment, the tube assembly 10 is cross-linked using radiation. In this method, the tube assembly 10 is passed under a radiation unit and the exposure causes cross-linking. It is envisioned that under some circumstances, it would be appropriate to cross-link individual components 12, 14, 20, and 22 and in other circumstances to cross-link the final product 10. In alternative embodiments, the material for the overmolded components 20 and 22 may be partially cross-linked prior to the overmolding, followed by subsequent overmolding. As detailed herein, cross-linking can also be performed by a silane process or a peroxide process, or combinations thereof, wherein cross-linking is completed in a hot bath. Each process has a cross-linking catalyst that causes the polymer to crosslink when certain temperature and pressure and/or humidity are used.

Additional details for manufacturing cross-linked overmolded plumbing tubes are disclosed in U.S. Pat. No. 6,287,501, the disclosure of which is expressly incorporated by reference herein.

Fastening tube 10 to end fittings 20 and 22 fixes the axial and radial positions of ends 19a, 19b and 31a, 31b of inner member 12 and outer member 14. Outer member 14 comprising a braided sleeve provides axial strength. Since outer member 14 cannot radially lengthen or shorten, outer member 14 provides axial strength by impairing axial lengthening or shortening of inner member 12. Similarly, outer member 14 comprising a braided sleeve provides radial strength, preventing radial expansion or contraction of inner member 12.

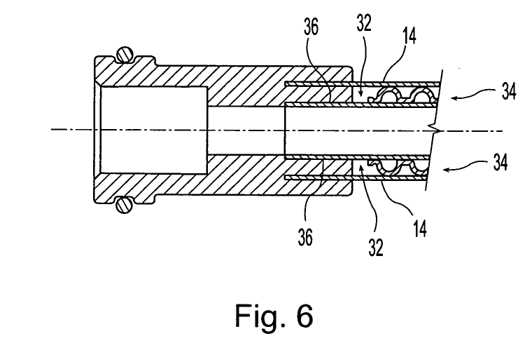

Now referring to FIG. 6, another illustrative embodiment is substantially similar to the previous embodiment described in FIGS. 2-5. However, inner member 32 includes corrugations 34 formed adjacent to sidewall 36 and positioned radially outwardly therefrom. Corrugations 34 may be distinct from inner member 32 which defines a smooth cylindrical inner surface for fluid flow there through. In a manner similar to that detailed above, corrugations 34 may be overmolded to end fittings 20 and 22.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains. Although the invention has been described in detail with reference to certain preferred embodiments, variations and modifications exist within the spirit and scope of the invention as described and defined in the following claims.

1. A tube assembly comprising:
a first tubular member formed of a cross-linked polymer, the first tubular member including a plurality of corrugations; and
a second tubular member coaxially receiving the first tubular member, the second tubular member including a plurality of interconnected strands.

2. (canceled)

3. The tube assembly of claim 1, wherein the first tubular member includes cross-linked polyethylene.

4. The tube assembly of claim 1, wherein the first tubular member includes cross-linked polyamide.

5. The tube assembly of claim 1, wherein the plurality of corrugations include ridges and valleys.

6. The tube assembly of claim 5, wherein the ridges are annular.

7. The tube assembly of claim 1, wherein the first tubular member includes a sidewall defining the plurality of corrugations.

8. The tube assembly of claim 7, wherein the plurality of corrugations are ribs.

9. The tube assembly of claim 1, wherein the plurality of corrugations are convoluted.

10. The tube assembly of claim 1, further comprising an end fitting coupling together adjacent ends of the first tubular member and the second tubular member.

11. The tube assembly of claim 10, wherein the end fitting is overmolded around the adjacent ends of the first tubular member and the second tubular member.

12. A tube assembly comprising:
a first tubular member formed of a cross-linked polyethylene, the first tubular member including a sidewall having a plurality of corrugations, and
a second tubular member coaxially receiving the first tubular member.

13. The tube assembly of claim 12, wherein the second tubular member includes a cross-linked polymer.

14. The tube assembly of claim 13, wherein the second tubular member includes cross-linked polyethylene.

15. The tube assembly of claim 13, wherein the second tubular member includes a plurality of stands.

16. The tube assembly of claim 15, wherein the plurality of strands are woven together to form a braid.

17. The tube assembly of claim 12, further comprising an end fitting coupling together adjacent ends of the first tubular member and the second tubular member.

18. The tube assembly of claim 17, wherein the end fitting is overmolded around the adjacent ends of the first tubular member and the second tubular member.

19. A tube assembly for use with a faucet, the tube assembly comprising:
an inner tubular member extending between opposing first and second ends and formed of a cross-linked polyethylene, the inner tubular member including a sidewall having a plurality of corrugations,
an outer tubular member extending between opposing first and second ends and receiving the inner tubular member, the outer tubular member including a plurality of cross-linked polyethylene strands, the strands being interwoven; and
an end fitting overmolded around the first end of the inner tubular member and the first end of the outer tubular member.

20. A faucet assembly comprising:
a water outlet;
a valve fluidly coupled to the water outlet;
a tube assembly fluidly coupling the valve to a water supply line, the tube assembly including a first tubular member formed of a cross-linked polyethylene and including a sidewall having a plurality of corrugations, and a second tubular member co-axially receiving the first tubular member.

21. The faucet assembly of claim 20, wherein the second tubular member includes a cross-linked polymer.

22. The faucet assembly of claim 20, further comprising an end fitting coupling together adjacent ends of the first tubular member and the second tubular member.

23. The faucet assembly of claim 20, wherein the end fitting is overmolded around the adjacent ends of the first tubular member and the second tubular member.

24. The faucet assembly of claim 20, wherein the outlet comprises at least one of a delivery spout and a side spray.
